(19) United States
(12) Patent Application Publication
(10) Pub. No.: US 2024/0200730 A1
(43) Pub. Date: Jun. 20, 2024

(54) TANK BASE FOR A PRESSURE CONTAINER

(71) Applicant: RATTIINOX S.R.L., Mariano Comense ( Como) (IT)

(72) Inventor: Walter RATTI, Mariano Comense (Como) (IT)

(21) Appl. No.: 18/556,339

(22) PCT Filed: Apr. 26, 2022
(86) PCT No.: PCT/IB2022/053841

§ 371 Date: Oct. 19, 2023

(30) Foreign Application Priority Data
Apr. 26, 2021 (IT) 102021000010442

(51) Int. Cl. F17C 13/08; F17C 7/02; F17C 13/02; F17C 13/04

(52) U.S. Cl. CPC F17C 13/08; F17C 7/02; F17C 13/026; F17C 13/04; F17C 2209/2181; F17C 2209/228

(57) ABSTRACT

A tank base for a pressure container having a tank base body made in a single piece is provided. The tank base body has an annular connection edge for connecting the tank base to the pressure container, and an inclined bottom wall, the annular connection edge and the inclined bottom wall delimiting a tank bottom cavity with edge surfaces and bottom wall surfaces converging towards a minimum portion. The minimum portion has a drainage opening. The inclined bottom wall is devoid of further drainage openings. The drainage opening is surrounded by a valve flange for connecting a clamp connection adapter unit that converts a bolt compression connection into a clamp compression connection for interchangeably connecting a valve device to the tank base.

### TECHNICAL FIELD OF THE INVENTION

The present invention belongs, in general, to the field of tank bases for a pressure container.

For example, the present invention relates to a tank base for a tank of a pressurized reactor having a tank bottom designed so as not to have process fluid accumulation zones. These tank bases have inclined surfaces, converging towards an outlet opening for the complete drainage of the process fluid.

Furthermore, the present invention relates to an assembly comprising a tank base and a clamp connection adapter unit for connecting an interception device, for example, a valve.

### BACKGROUND ART

A mixer is known from document US2004076076A1 for a liquid placed in a sterile container having a wall comprising a welding pin having a distal end inside the wall and having a proximal end outside the wall. The welding pin has a hole therein extending through the proximal end of the welding pin. A motor-operated magnet actuation unit is arranged in the hole in the welding pin. A hub bearing the rotors is rotatably mounted on the welding pin. A magnet operated complex is mounted in the hub and arranged in close proximity to the magnet operated complex but it is separated therefrom by a liquid seal gasket. The magnet actuation assembly includes a plurality of circumferentially spaced apart permanent actuated magnets, which are caged by bars to prevent the permanent actuated magnets from moving with respect to the hub. This solution comprises no drainage opening for the liquid placed in the container.

A group of replaceable nozzles is known from document GB2097081A for an opening in the wall of a coated pressure container, said group comprises a flange arranged so as to extend externally from the wall of the container about the opening and to be connected to the jacket of the container, to define a passage through the jacket; a nozzle extending, in use, through the passage and having a first portion extending externally from the passage and a second portion, which is arranged inside the passage and has an outer surface complementary to an inner surface of the flange; a gasket arranged between the complementary flange and the surfaces of the nozzle to provide a fluid seal surface therebetween; and a clamp means cooperating with the jacket and the first nozzle portion to fix the nozzle within the passage and against the gasket. This known solution does not have a container bottom connected to the container and furthermore, it does not have the possibility to connect a mixer to the container in proximity, but separate from said opening. Furthermore, this solution has, in all embodiments thereof, the body of the element, which delimits the opening associated with the container, creating wide portions of pools of liquids, which cannot be drained, except by completely dismantling the container and separating this body from the walls of the container.

Document WO2009149511A1 shows a support for use in a pump unit, the pump unit including a plurality of component parts, which include a seal housing, a drive shaft having a rotation axis, an impeller and a pump housing, the pump housing including a main jacket. The pump housing support comprises: a base and an assembly element, which includes a part of the body onto which a part of the pump housing part can be assembled and a positioning flange extending therefrom, the positioning flange having a first and second positioning surface on the opposite sides thereof, in which the main coating is positioned on the first positioning surface and the seal housing is positioned on the second positioning surface.

The use is known of welded bases made with inner surfaces converging towards an outlet valve in tanks for chemical systems, for example, in reactors.

The tank base is a component for manufacturing mixing containers, also with small and very small volumes, for example, on counters or on a pilot scale for critical biotechnological and pharmaceutical mixing applications. For example, the base can be used to construct relatively small tanks, to facilitate the mixing of volumes up to 0.8 L.

In order to satisfy processing needs, the tank base can be provided with openings for connecting mixers. These known bases are designed and produced from a single piece of full bar, which incorporates the bottom wall of the tank, the connection flange of the mixer and the body of the outlet valve.

The main problem of these small bases is the absolute uniqueness thereof for each type and size of mixer and for each type and size of valve.

In fact, for the reduced sizes of the tank, the requirement imposed by laws, for example, the pressure equipment directive, commonly called PED (from the English, Pressure Equipment Directive), a directive of the European Union 2014/68/UE, impose to pressure containers manufactured with welding of the different components, such as the mixer flanges and the flanges of the valves, to maintain a distance not closer than 25 mm. If it is necessary to make weldings closer than 25 mm, complex and costly analyses must be carried out on each piece produced in order to check the integrity and perfect seal of the component.

This limitation results in these tank bases being made in a single piece by mechanical machining from full, wherein the connection flange of the mixer is obtained via machining by swarf removal and a part of the valve body of the process fluid interception device.

The choice of the type of stirrer, make, model and configuration of the impeller requires lengthy validation times due to the study of the effect of mixing the product. If the bottom of the tank is realized from full, custom-made, it must only be realized after such study is complete, and, consequently, the tank realization times are considerably longer.

Furthermore, it is often necessary to provide a further connection to a conduit for a cleaning fluid inlet valve, a conduit, which usually converges into the valve body made in a single piece in the tank base, as shown in FIGS. 1, 2 and 3 illustrating a solution of the state-of-the-art.

Therefore, the need is strongly felt to have, in the same tank bottom, flexibility for providing the connection flange of the mixer and the connection flange of the valve, avoiding having to comprise weldings close to one another.

### OBJECT AND SUMMARY OF THE INVENTION

Therefore, it is the object of the present invention to overcome the drawbacks of the state-of-the-art and allow achieving the aforesaid needs, by suggesting a tank base of a pressure container capable of ensuring adequate flexibility on changing the type and/or size of the mixer and/or the process fluid interception valve.

This and other objects are achieved by an assembly as claimed in claim 1.

Some advantageous embodiments are the subject of the dependent claims.

Furthermore, this and other objects are achieved by an assembly according to claim 19, an assembly set according to claims 20 and 21, a method for manufacturing a tank base according to claim 24 and a method for manufacturing a tank base assembly according to claim 25.

By virtue of the general embodiment and the variants described above and further described below, it is possible to obtain the following advantages.

The suggested tank base allows use for different types of mixers and also for different types of fluid interception valves.

In particular, the suggested solutions allow avoiding having weldings close to one another, i.e. less than 25 mm apart from one another, while allowing mixer connection flanges to be used, which are much larger than those allowed in the tank bases of the state-of-the-art. In other words, the mixer opening, which creates the housing for the mixer flange can also be made very large, capable of coming come close to the valve coupling seat

The suggested tank base body has zones with a greater thickness, or stems, where it is possible to connect load cells directly to the base.

Furthermore, it is possible to keep the drainage angle of the inclined bottom wall optimum and equal for all solutions and types of mixers and valves, which are desired to be associated with the tank base.

By virtue of the suggested solutions, the manufacturing costs are significantly reduced with respect to those of the solutions of the state-of-the-art, which comprise making, in a single piece with the inclined bottom wall, both the connection flange of the mixer and the valve body. In particular, much less raw material is used, there is less material to be removed and much simpler machinings are carried out.

By virtue of the suggested solutions, the supply times are much shorter (in fact, it is possible to keep a smaller number of tank bases in stock, in terms of size), the tank or apparatus, which uses the tank, can be supplied more quickly (the delivery times for the solutions where all the parts are made from full are, on average, 8-10 weeks, causing problems for the tank manufacturers). Alternatively, tank manufacturers can keep these tank bases made according to the invention in stock, because they can be selected in order to obtain any tank configuration.

By virtue of the suggested solutions, the construction of the tank is much simpler. Furthermore, the process fluid interception valve is not present during the realization of the tank, allowing simpler machinings and reducing the probability of faults with the valve body.

The pressure tests to be carried out on the tanks are also easier, since the valve can be replaced with a cap to perform the pressure tests.

As a function of the process to be carried out, the pharmaceutical companies generally “validate” some specifications concerning the mixing or mixer to be used, or the features thereof (such as minimum speed, minimum mixable volume, etc.), indeed they often validate a brand and a specific model. By virtue of these tank base solutions, tank manufacturers do not have to purchase a specific base for the single application (costly and time-consuming), but they can always choose the tank base of the size suited for the tank and weld the correct mixer flange (mixer manufacturer standard) according to the specifications set by the customer and choose the interception valve again in keeping with the customer's specifications.

Having the possibility to use a standardized tank base, onto which it is possible to weld a standardized support of any stirrer, or mixer, as it is a construction based on standard components, the manufacturing of the tank will be much quicker, satisfying the same technical requirements as the solution with a tank base made from full. This ensures greater versatility, since different types of stirrers and discharge valves can be combined. Furthermore, in the event of reusing the tank for another purpose, if the mixer is compatible with the new application, it will be possible to replace the discharge valve to complete the new application.

### BRIEF DESCRIPTION OF THE DRAWINGS

Further features and advantages of the invention will become apparent from the description provided below of preferred embodiments thereof, given by way of non-limiting example, with reference to the accompanying drawings, in which:

FIG. 1 shows an axonometric view of a tank base according to the state-of-the-art, drawn with a continuous line, applied to a tank, with a dashed line;

FIGS. 2 and 3 illustrate an axonometric and cross-sectional view of the tank base in FIG. 1;

FIG. 4 shows an axonometric view of a tank base according to the present invention, from the side of the tank bottom cavity;

FIG. 4 shows an axonometric view of a tank base assembly from the side of the welding pocket and clamp connection adapter unit;

FIGS. 5, 6, 7 and 8 show the front, side, upper or tank side, lower or outer tank side views of the tank base assembly in FIG. 4;

FIG. 9 shows a cross-section of the tank base assembly in FIG. 4;

FIGS. 10 and 11 show a tank side axonometric and cross-sectional view of the tank base assembly, in which a mixer opening has been made;

FIG. 12 shows a detail of a tank base with an associated clamp connection adapter unit, which sandwiches a connection flange of a valve device;

FIGS. 13, 14 and 15 illustrate a tank side axonometric view, an outer side axonometric view and a cross-sectional view of a tank base assembly with the clamp connection adapter unit and, welded mixer flange, according to a first variant;

FIGS. 16, 17, 18, 19 and 20 show a cross-sectional view of a tank base assembly with the clamp connection adapter unit and, welded mixer flange, according to a second, third, fourth and fifth variant;

FIGS. 21, 22 and 23 show an axonometric view from three different view points of a tank base assembly with which a mixer is associated, a valve device for intercepting the process fluid and a secondary valve for a cleaning fluid;

FIG. 24 shows a side view with separate parts of a tank base assembly with which a mixer is associated, a valve device for intercepting the process fluid according to a further embodiment;

FIG. 25 illustrates a side view of an assembly comprising a pressure container with which a tank base is associated to which a valve device is connected and a mixer, through a mixer flange, as well as a temperature probe and sampling valve to said tank base;

FIG. 26 shows a side view orthogonal to the view in FIG. 25 of the assembly in FIG. 24;

FIG. 27 illustrates an axonometric view of the assembly in FIG. 25 in which the pressure container has been removed from the tank base;

FIG. 28 illustrates an axonometric view with separate parts of the assembly in FIG. 27.

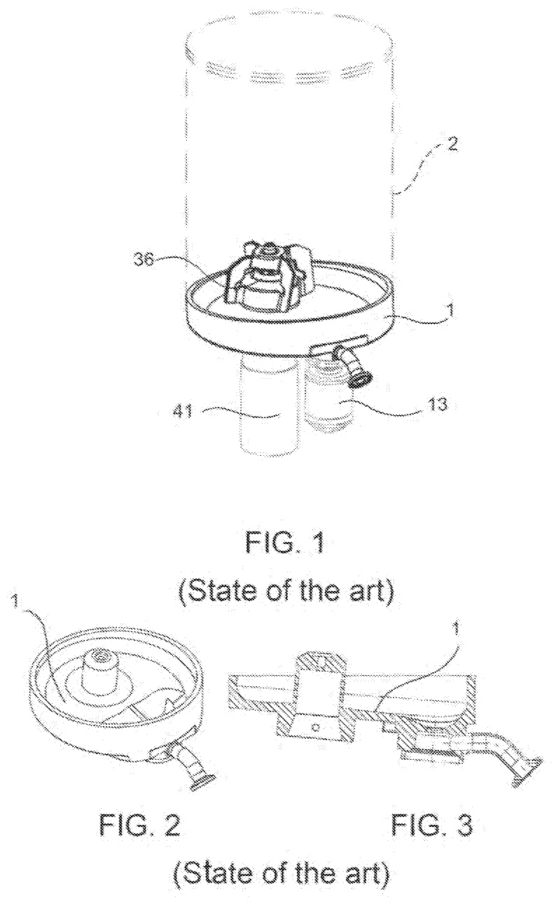

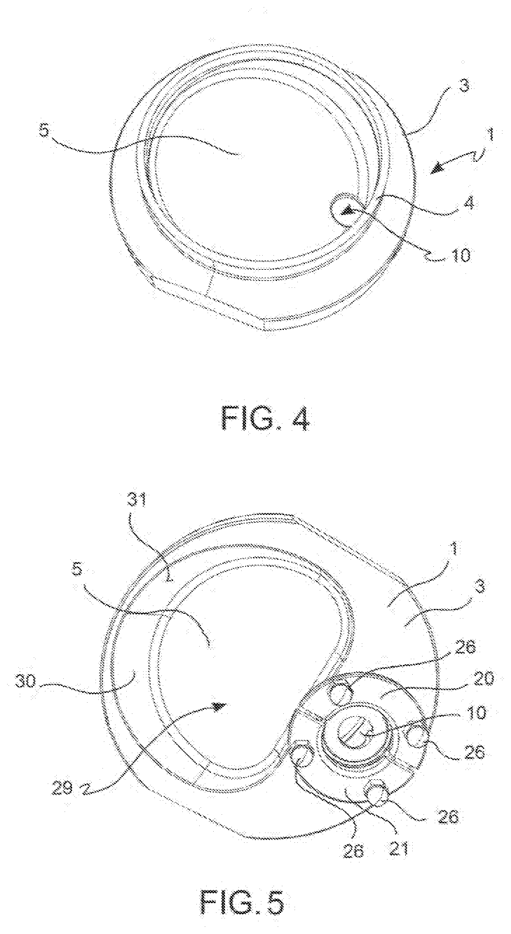

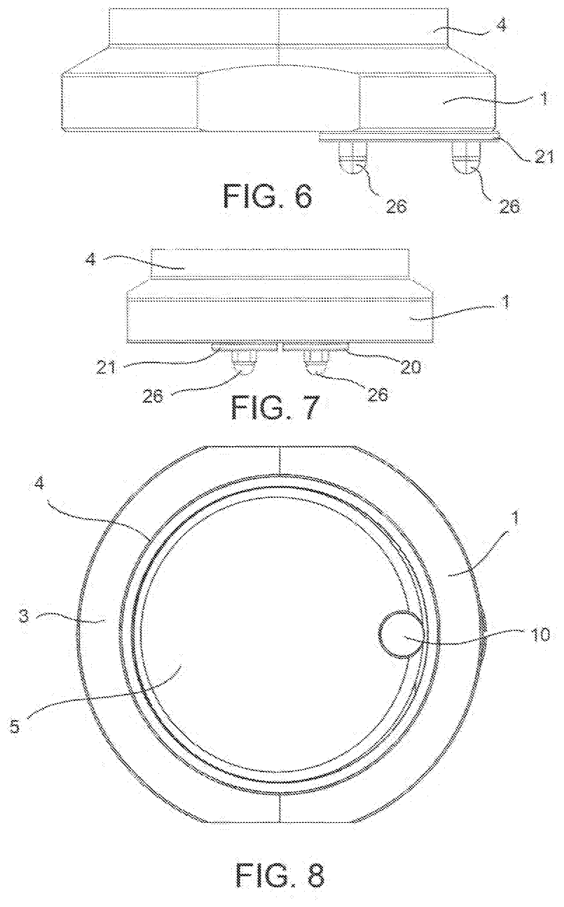

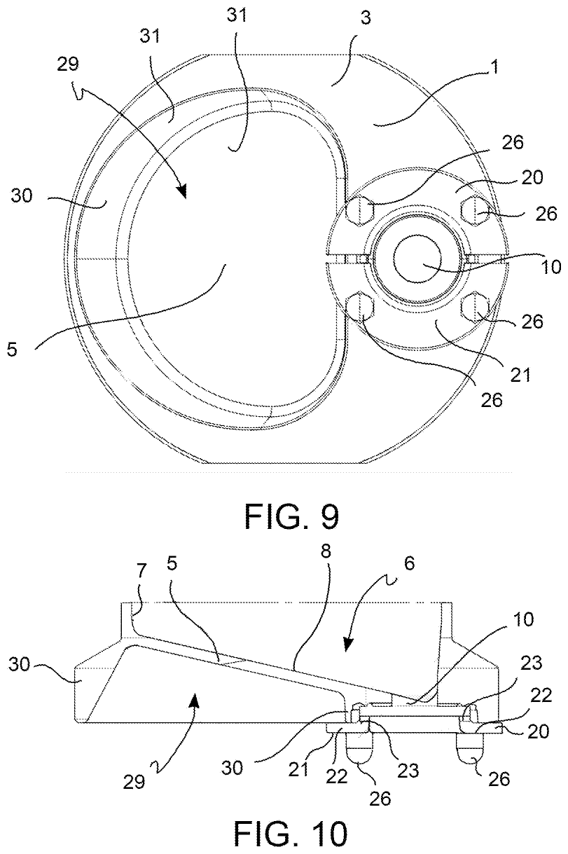

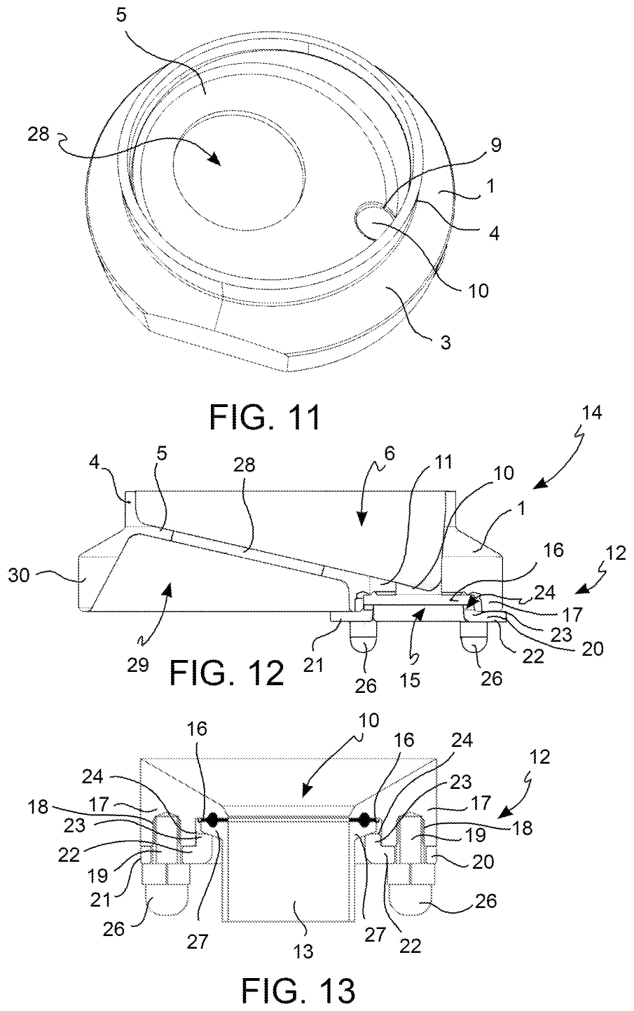

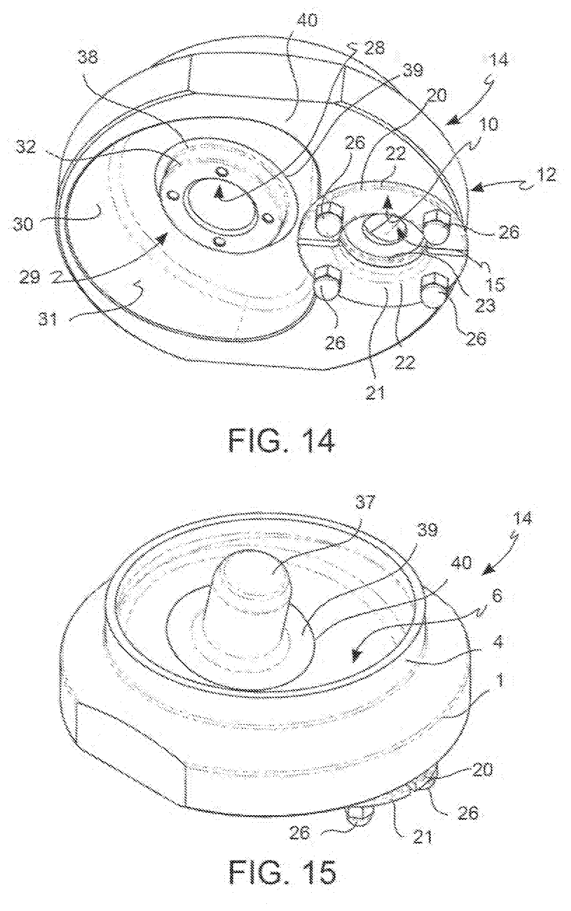

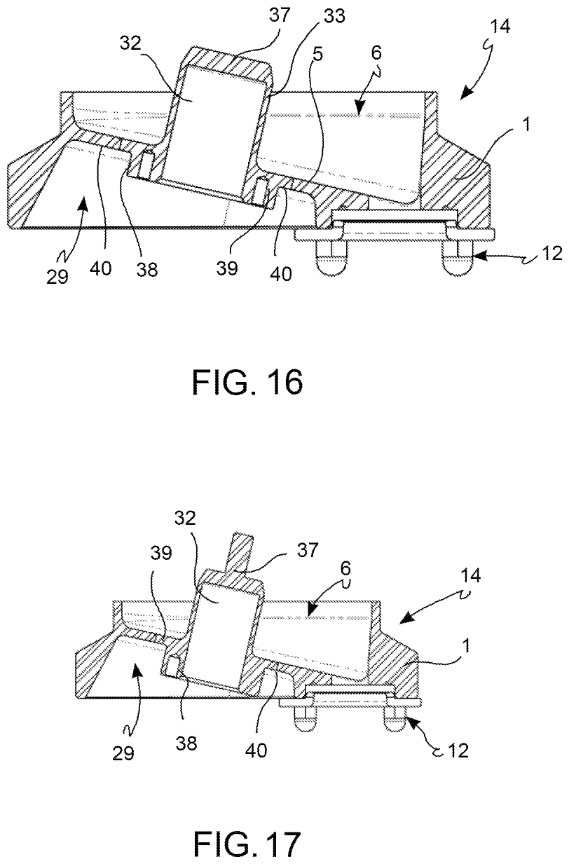

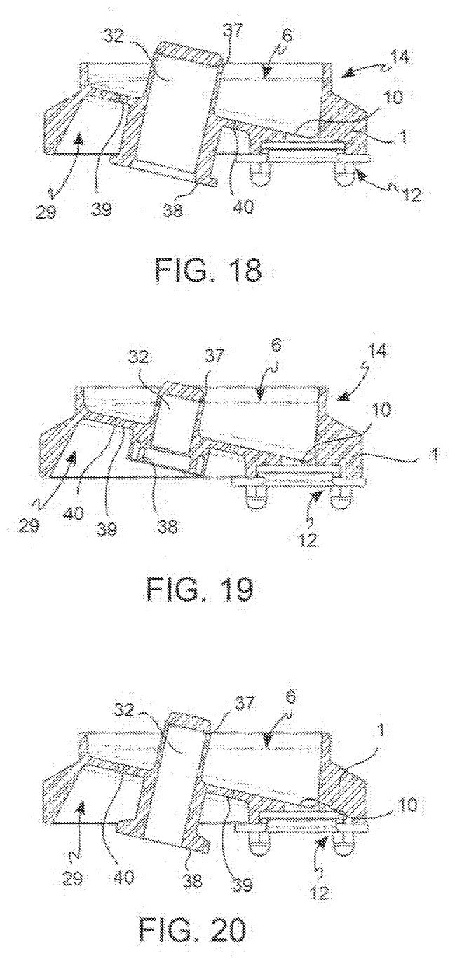

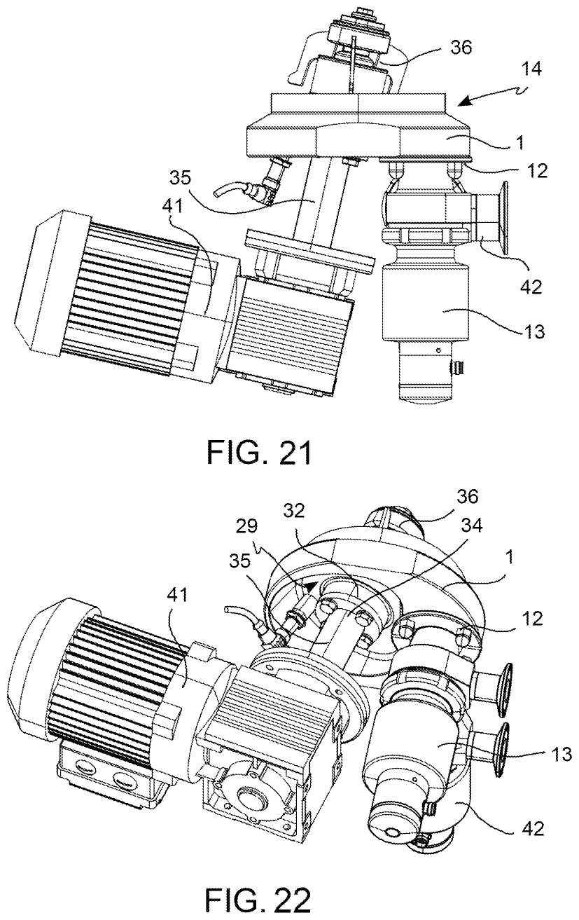

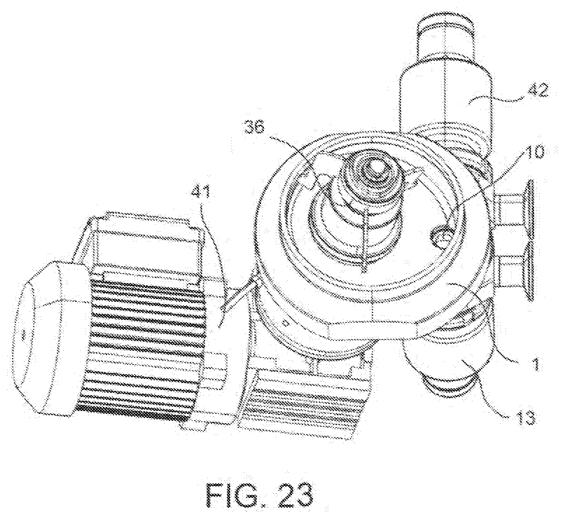

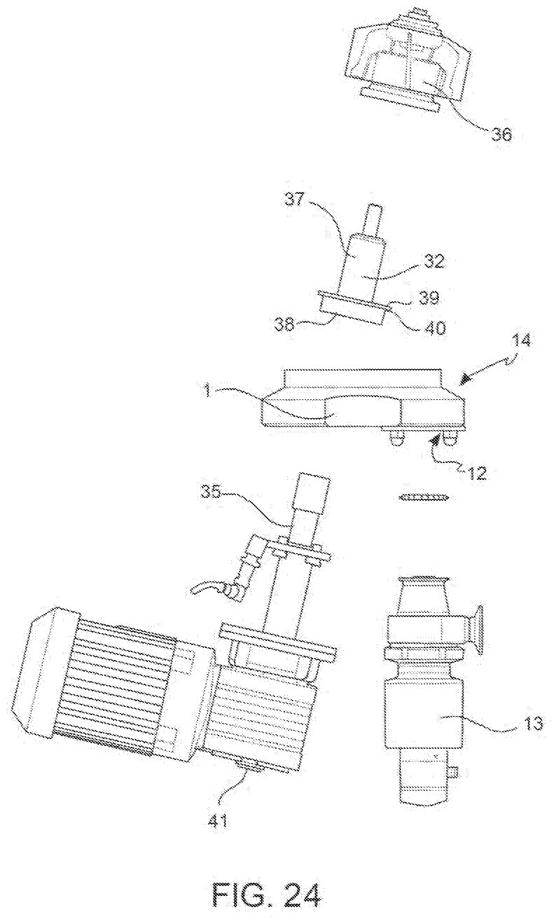

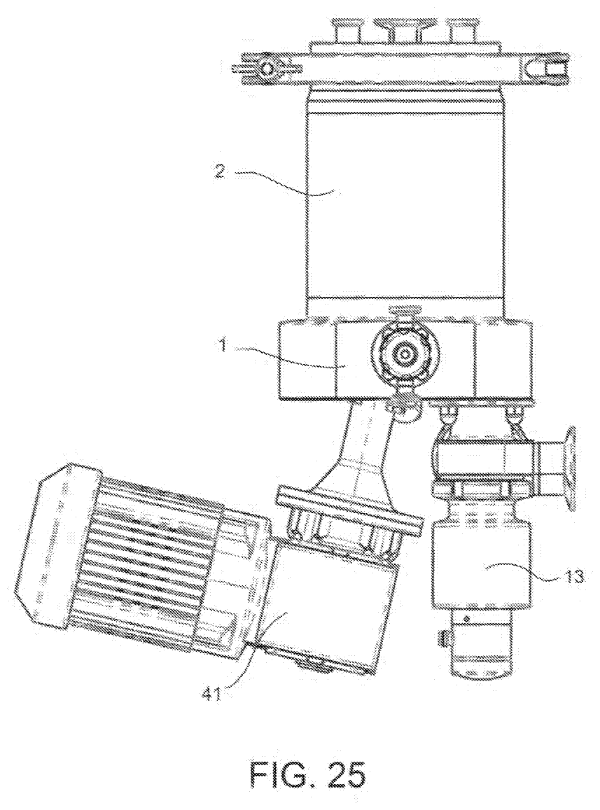

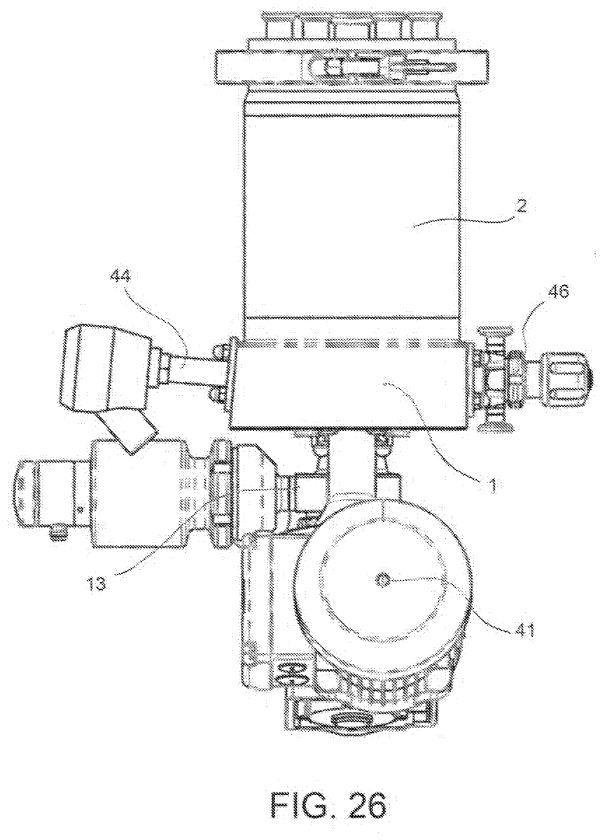

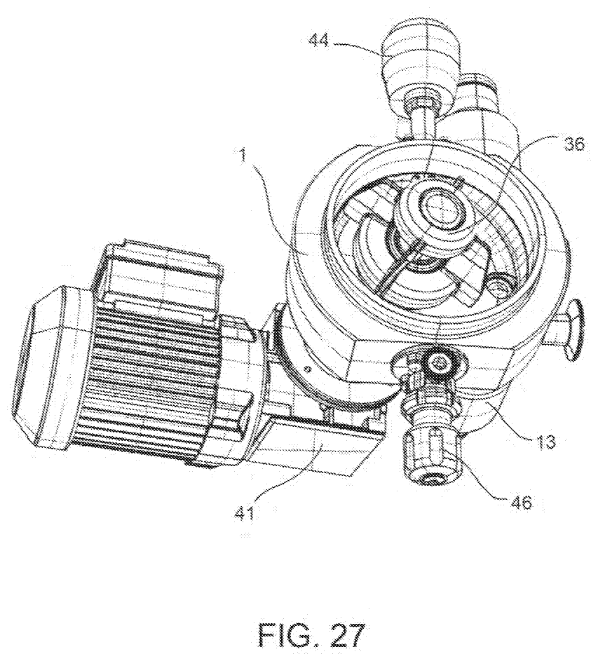

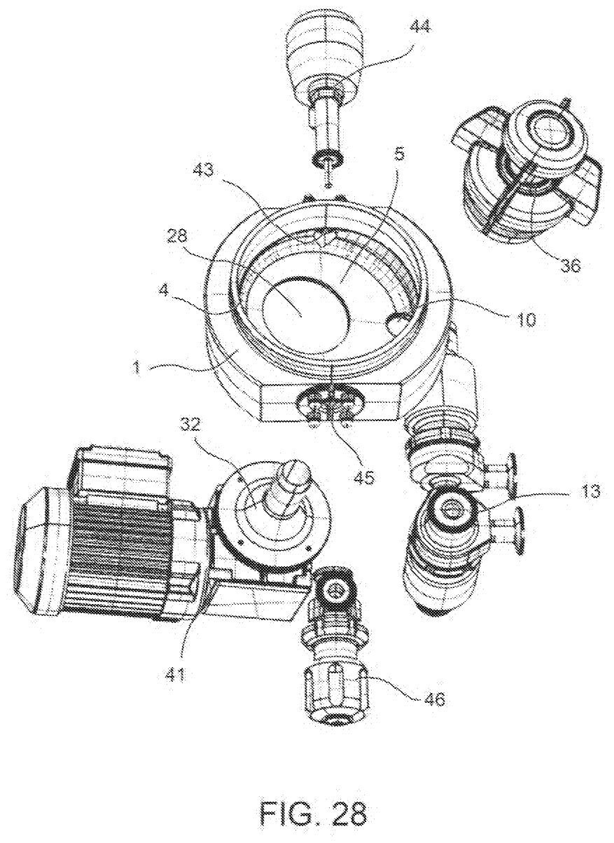

### DETAILED DESCRIPTION OF SOME PREFERRED EMBODIMENTS OF THE INVENTION

The present invention will now be described in detail with reference to the accompanying drawings to enable a person skilled in the art to realize and use it. Various changes to the embodiments described will be readily apparent to those skilled in the art and the general principles described may be applied to other embodiments and applications without departing from the scope of protection of the present invention, as defined in the appended claims. Therefore, the present invention should not be considered as limited to the embodiments described and shown, but should be granted the broadest scope of protection in compliance with the features described and claimed.

Unless otherwise defined, all the technical and scientific terms used herein have the same meaning commonly used by those of ordinary skill in the field of the present invention. In case of a conflict, the present description, including the definitions provided, will be binding. Furthermore, the examples are merely provided for illustrative purposes, and as such should not be considered as limiting.

In order to facilitate the understanding of the embodiments described herein, reference will be made to some specific embodiments and a specific language will be used to describe them. The terminology used in this document has the purpose of describing only particular embodiments, and is not intended to limit the scope of the present invention.

According to an embodiment, there is provided an assembly of a pressure container 2 and a valve device 13. Said assembly comprises a tank base 1 for said pressure container 2 comprising a tank base body 3. Said tank base body 3 is made in a single piece.

Said tank base body 3 comprises an annular connection edge 4, for connecting said tank base 1 to said pressure container 2, and an inclined bottom wall 5, to allow a fluid to flow, by gravity, towards a minimum portion 9 thereof, said annular connection edge 4 and inclined bottom wall 5 delimiting a tank bottom cavity 6 with edge surfaces 7 and bottom wall surfaces 8 converging towards said minimum portion 9.

Said minimum portion 9 comprises a drainage opening 10 for the complete drainage, by gravity, of a fluid contained in said pressure container 2.

Said inclined bottom wall 5 is made devoid of any further drainage openings.

Said drainage opening 10 is surrounded by a valve flange 11 for connecting a clamp connection adapter unit 12, which converts a bolt compression connection into a clamp compression connection for interchangeably connecting a valve device 13 to said tank base 1.

According to an embodiment, said valve flange 11 delimits, in the portion opposite to said tank bottom cavity 6 thereof, a valve coupling seat 15 delimited close to said drainage opening 10 by at least one direct valve support plane 16 opposite to said tank bottom cavity 6.

Said valve support plane 16 is externally delimited by a valve seat edge 17 in the thickness of which there are provided threaded blind holes 18 able to accommodate threaded stems 19 protruding from said valve seat edge 17.

According to an embodiment, said tank base 1 comprises a clamp connection adapter unit 12.

According to an embodiment, said clamp connection adapter unit 12 is a Zero Dead Leg connection flange, or ZDL connection, comprising at least two clamps 20, 21 extending about said drainage opening 10, each for an arc equal to, or less than 180DEG.

Each clamp 20, 21 comprises an arched connection portion 22 and a folded tightening portion 23.

Said folded tightening portion 23 enters said valve coupling seat 15 and faces said valve support plane 16 creating a support and tightening counter-surface 24.

Said valve seat edge 17 with the threaded blind holes 18 thereof accommodates threaded stems 19 protruding from said valve seat edge 17.

Said arched connection portion 20 faces said valve seat edge 17 and the connection seats 25 thereof accommodate the portions of said threaded stems 19.

Tightening bolts 26 are screwed to the free ends of the threaded stems 19 and tighten said clamps 20, 21 so as to sandwich a valve flange 27 of a valve device 13 between the support and tightening counter-surfaces 24 thereof and said valve support plane 16.

According to an embodiment, a mixer opening 28 is made in said inclined bottom wall 5, which is not adapted to drain fluid, wherein alternatively:
said mixer opening 28 is a through opening, which puts a welding pocket 29 in communication with said tank bottom cavity 6;
or
said mixer opening 28 is a circular through opening, which puts a welding pocket 29 in communication with said tank bottom cavity 6.

A mixer flange 32 is firmly connected to said mixer opening 28 for the seal connection of a mixer 34.

Said mixer flange 32 and said mixer 34 occlude said mixer opening 28.

According to an embodiment, said assembly comprises said mixer flange 32; and said mixer flange 32 is inserted and welded to the edges of said mixer opening 28.

According to an embodiment, said welding pocket 29 has a “D”-plan shape.

According to an embodiment, said welding pocket 29 is delimited by said inclined bottom wall 5 and welding pocket edges 30 forming inner welding pocket surfaces 31.

The inner welding pocket surfaces 31 are divergent moving away from said inclined bottom wall 5.

According to an embodiment, said mixer flange 32 comprises a mixer flange body 33 for supporting a mixer 34.

According to an embodiment, said mixer flange 32 comprises a mixer flange body 33 for accommodating a mixer shaft 34 and rotatably freely supporting a mixer head 35 at least partially inside said tank bottom cavity 6.

According to an embodiment, said mixer flange 32 comprises a mixer flange body 33.

Said mixer flange body 33 comprises a first mixer flange body portion 37 extending into said tank bottom cavity 6.

Said mixer flange body 33 comprises a second mixer flange body portion 38 extending away from said inclined bottom wall 5.

According to an embodiment, said second mixer flange body portion 38 is at least partially accommodated in said welding pocket 29.

According to an embodiment, said mixer flange 32 comprises at least one lateral mixer welding extension 39.

Said at least one lateral mixer welding extension 39 comprises welding edges 40 adapted to be welded to edges of said mixer opening 28.

According to an embodiment, said assembly 14 comprises a mixer 34.

Said mixer 34 comprises a mixer head 36 supported on the side of the inclined bottom wall 5 delimiting said tank bottom cavity 6.

Said mixer 34 comprises a gear motor unit 41 adapted to move said mixer head 36; said gear motor unit 41 is secured by said mixer flange 32 welded to said inclined bottom wall 5.

According to an embodiment, said assembly comprises said tank base 1, a mixer 34 and a valve device 13 for intercepting a process fluid.

According to an embodiment, said assembly comprises said tank base 1, a mixer 34 and a valve device 13 for intercepting a process fluid and a secondary valve 42 for intercepting a cleaning fluid, wherein said secondary valve 42 is fluidically joined to said valve device 13.

According to an embodiment, said annular connection edge 4 comprises a temperature probe port 43 for fluidically sealably connecting a temperature probe 44, thus without allowing a fluid to drain, and detecting the temperature of a fluid contained in said tank bottom cavity 6.

According to an embodiment, said annular connection edge 4 comprises a sampling valve port 45 for fluidically sealably connecting a sampling valve 46 and without allowing the complete drainage of a fluid, and collecting a sample, also in very small residual volumes of fluid.

According to an embodiment, there is provided a valve device assembly 13 and a tank base 1.

Said tank base 1 is adapted to be connected to a pressure container 2.

Said tank base 1 comprising a tank base body 3. Said tank base body 3 is made in a single piece.

Said tank base body 3 comprises an annular connection edge 4, for connecting said tank base 1 to said pressure container 2, and an inclined bottom wall 5, to allow a fluid to flow, by gravity, towards a minimum portion 9 thereof, said annular connection edge 4 and inclined bottom wall 5 delimiting a tank bottom cavity 6 with edge surfaces 7 and bottom wall surfaces 8 converging towards said minimum portion 9.

Said minimum portion 9 comprises a drainage opening 10 for the complete drainage, by gravity, of a fluid contained in said pressure container 2.

Said inclined bottom wall 5 is made devoid of any further drainage openings.

Said drainage opening 10 is surrounded by a valve flange 11 for connecting a clamp connection adapter unit 12, which converts a bolt compression connection into a clamp compression connection for interchangeably connecting a valve device 13 to said tank base 1.

A mixer opening 28 is made in said inclined bottom wall 5, which is not adapted to drain fluid.

Said mixer opening 28 is a through opening, which puts a welding pocket 29 in communication with said tank bottom cavity 6.

A mixer flange 32 is firmly connected to said mixer opening 28 for the seal connection of a mixer 34.

Said mixer flange 32 and said mixer 34 occlude said mixer opening 28.

According to an embodiment, an assembly set is provided according to any one of the embodiments described above. Said assembly set comprises a plurality of tank base assemblies 14, wherein said tank bases 14 each comprise a mixer opening 28. The mixer openings 28 of the different tank bases 14 have different extension sizes from one another.

A respective mixer flange 32 is firmly connected to each mixer opening 28 for the seal connection of a mixer 34.

According to an embodiment, an assembly set is provided according to any one of the embodiments described above. Said assembly set comprises at least one tank base 14. Said tank base 14 comprises a mixer opening 28.

A mixer flange 32 selected from a set of mixer flanges of different sizes is firmly connectable to said mixer opening 28 for the seal connection of a mixer 34.

According to an embodiment, a set of assemblies according to one of the embodiments described above, provides that all the mixer flanges 32 comprise a lateral mixer welding extension 39 having welding edges 40 of identical sizes.

Each mixer flange 32 comprises a mixer flange body 33; said mixer flange body 33 comprises a first mixer flange body portion 37 adapted to extend into a tank bottom cavity 6; said mixer flange body 33 comprises a second mixer flange body portion 38 adapted to extend away from an inclined tank base 1 bottom wall 5; and wherein said second mixer flange body portion 38 is adapted to be at least partially accommodated in a tank base 1 welding pocket 29.

Each mixer flange 32 has a size and/or shape of said first mixer flange body portion 37, which is different from the other mixer flanges 32 of the same set of mixer flanges.

According to an embodiment, each mixer flange 32 comprises a mixer flange body 33; said mixer flange body 33 comprises a first mixer flange body portion 37 adapted to extend into a tank bottom cavity 6; said mixer flange body 33 comprises a second mixer flange body portion 38 adapted to extend away from an inclined tank base 1 bottom wall 5; and wherein said second mixer flange body portion 38 is adapted to be at least partially accommodated in a tank base 1 welding pocket 29.

Each mixer flange 32 has a size and/or shape of said second mixer flange body portion 38, which is different from the other mixer flanges 32 of the same set of mixer flanges.

The present invention further relates to a method for manufacturing a tank base 1, wherein there is provided, alternatively,
the step of
melting and machining, by swarf removal, a tank base having the features in claim 1;
or
machining, by swarf removal from a full piece, a tank base having the features in claim 1.

The present invention further relates to a method for manufacturing a tank base assembly 14, wherein there are provided the steps of:
providing an assembly 14 according to any one of claims 1 to 23;
connecting to said valve flange 11 a clamp connection adapter unit 12, which converts a bolt compression connection into a clamp compression connection for interchangeably connecting a valve device 13 to said tank base 1.

The present invention also relates to a method further comprising the step of:
making a mixer opening 28 in said inclined bottom wall 5;
welding a mixer flange 32 to the edges of said mixer opening 28.

The present invention also relates to a method further comprising the step of:
connecting a mixer 34 to said mixer flange 32;
connecting a valve device 13 to said clamp connection adapter unit 12.

According to a general embodiment, a tank base 1 for a pressure container 2 comprises a tank base body 3 made in a single piece.

Said tank base body 3 comprises an annular connection edge 4, for connecting said tank base 1 to said pressure container 2, and an inclined bottom wall 5.

Said annular connection edge 4 and inclined bottom wall 5 delimit a tank bottom cavity 6 with edge surfaces 7 and bottom wall surfaces 8 converging towards a minimum portion 9. Said minimum portion 9 comprising a drainage opening 10.

Said inclined bottom wall 5 is made devoid of any openings.

Said drainage opening 10 is surrounded by a valve flange 11 for connecting a clamp connection adapter unit 12, which converts a bolt compression connection into a clamp compression connection for interchangeably connecting, and sandwiching, a valve device 13 to said tank base 1.

According to an embodiment, said valve flange 11 delimits, in the portion thereof opposite to said tank bottom cavity 6, a valve coupling seat 15.

Said valve coupling seat 15 is delimited, close to said drainage opening 10, by at least one direct valve support plane 16 opposite to said tank bottom cavity 6.

Said valve support plane 16 is externally delimited by a valve seat edge 17 in the thickness of which there are provided threaded blind holes 18 able to accommodate threaded stems 19 protruding from said valve seat edge 17.

According to a general embodiment, a tank base assembly 14 comprises a tank base 1 according to any of the embodiments described above. Said tank base 1 comprises a clamp connection adapter unit 12.

According to an embodiment, said clamp connection adapter unit 12 is a Zero Dead Leg connection flange, or ZDL connection, comprising at least two clamps 20, 21 extending about said drainage opening 10, each for an arc equal to, or less than 180DEG.

Each clamp 20, 21 comprises an arched connection portion 22 and a folded tightening portion 23.

Said folded tightening portion 23 enters said valve coupling seat 15 and faces said valve support plane 16 creating a support and tightening counter-surface 24.

Said valve seat edge 17 with the threaded blind holes 18 thereof accommodates threaded stems 19 protruding from said valve seat edge 17.

Said arched connection portion 20 faces said valve seat edge 17 and the connection seats 25 thereof accommodate the portions of said threaded stems 19.

Tightening bolts 26 are screwed to the free ends of the threaded stems 19 and tighten said clamps 20, 21 so as to sandwich a valve flange 27 of a valve device 13 between the support and tightening counter-surfaces 24 thereof and said valve support plane 16.

According to an embodiment, a mixer opening 28 is made in said inclined bottom wall 5.

According to an embodiment, said mixer opening 28 is a through opening, which puts a welding pocket 29 in communication with said tank bottom cavity 6.

According to an embodiment, said mixer opening 28 is a circular through opening, which puts a welding pocket 29 in communication with said tank bottom cavity 6.

According to an embodiment, said welding pocket 29 has a “D”-plan shape.

According to an embodiment, said welding pocket 29 is delimited by said inclined bottom wall 5 and welding pocket edges 30 forming inner welding pocket surfaces 31.

The inner welding pocket surfaces 31 are divergent moving away from said inclined bottom wall 5.

According to an embodiment, said assembly comprises a mixer flange 32.

Said mixer flange 32 is inserted and welded to the edges of said mixer opening 28.

According to an embodiment, said mixer flange 32 comprises a mixer flange body 33 for supporting a mixer 34.

According to an embodiment, said mixer flange 32 comprises a mixer flange body 33 for accommodating a mixer shaft 34 and rotatably freely supporting a mixer head 35 at least partially inside said tank bottom cavity 6.

According to an embodiment, said mixer flange 32 comprises a mixer flange body 33.

According to an embodiment, said mixer flange body 33 comprises a first mixer flange body portion 37 extending into said tank bottom cavity 6.

According to an embodiment, said mixer flange body 33 comprises a second mixer flange body portion 38 extending away from said inclined bottom wall 5.

According to an embodiment, said second mixer flange body portion 38 is at least partially accommodated in said welding pocket 29.

According to an embodiment, said mixer flange 32 comprises at least one lateral mixer welding extension 39.

According to an embodiment, said at least one lateral mixer welding extension 39 comprises welding edges 40 adapted to be welded to edges of said mixer opening 28.

According to an embodiment, said assembly 14 comprises a mixer 34.

According to an embodiment, said mixer 34 comprises a mixer head 36 supported on the side of the inclined bottom wall 5 delimiting said tank bottom cavity 6.

According to an embodiment, said mixer 34 comprises a gear motor unit 41 adapted to move said mixer head 36; said gear motor unit 41 is secured by a mixer flange 32 welded to said inclined bottom wall 5.

According to an embodiment, said assembly comprises said tank base 1, a mixer 34 and a valve device 13 for intercepting a process fluid.

According to an embodiment, said assembly comprises a tank base 1, a mixer 34 and a valve device 13 for intercepting a process fluid and a secondary valve 42 for intercepting a cleaning fluid, wherein said secondary valve 42 is fluidically joined to said valve device 13.

The present invention further relates to a set of assemblies 14 comprising a plurality of assemblies according to any one of the embodiments described above, wherein the tank bases 1 each have mixer openings 28 having different extension sizes from one another.

The present invention further relates to a set of mixer flanges 32.

In this set, all the mixer flanges 32 comprise a lateral mixer welding extension 39 with welding edges 40 of identical sizes.

Each mixer flange 32 comprises a mixer flange body 33; said mixer flange body 33 comprises a first mixer flange body portion 37 adapted to extend into a tank bottom cavity 6; said mixer flange body 33 comprises a second mixer flange body portion 38 adapted to extend away from an inclined tank base 1 bottom wall 5; and wherein said second mixer flange body portion 38 is adapted to be at least partially accommodated in a tank base 1 welding pocket 29.

Each mixer flange 32 has a size and/or shape of said first mixer flange body portion 37, which is different from the other mixer flanges 32 of the same set of mixer flanges.

According to an embodiment, each mixer flange 32 has a size and/or shape of said second mixer flange body portion 38, which is different from the other mixer flanges 32 of the same set of mixer flanges.

The present invention further relates to a method for manufacturing a tank base 1, wherein there is provided, alternatively, the step of
melting and machining, by swarf removal, a tank base having the features in claim 1;
or
machining, by swarf removal from a full piece, a tank base having the features in claim 1.

According to a further alternative and optional procedure of implementing the method, there are provided the steps of:
comprising an assembly 14 according to any one of claims 3 to 10;
connecting to said valve flange 11 a clamp connection adapter unit 12, which converts a bolt compression connection into a clamp compression connection for interchangeably connecting a valve device 13 to said tank base 1.

According to a further alternative and optional way of executing the method, there are further provided the steps of:
making a mixer opening 28 in said inclined bottom wall 5;
welding a mixer flange 32 to the edges of said mixer opening 28.

According to a further alternative and optional way of executing the method, there are further provided the steps of:
connecting a mixer 34 to said mixer flange 32;
connecting a valve device 13 to said clamp connection adapter unit 12.

In order to meet specific, contingent needs, a person skilled in the art may make several changes and adaptations to the above-described embodiments and may replace elements with other functionally equivalent ones, without thereby departing from the scope of the following claims.

### REFERENCE SIGNS

1 tank base
2 pressure container or tank
3 tank base body
4 annular connection edge
5 inclined bottom wall
6 tank bottom cavity
7 edge surfaces
8 bottom wall surfaces
9 minimum portion
10 drainage opening
11 valve flange
12 clamp connection adapter unit
13 valve device
14 tank base assembly
15 valve coupling seat
16 valve support plane
17 valve seat edge
18 threaded blind holes
19 threaded stems
20 clamp
21 clamp
22 arched connection portion
23 folded tightening portion
24 support and tightening counter-surface
25 connection seats thereof
26 tightening bolts
27 valve flange
28 mixer opening
29 welding pocket
30 welding pocket edges
31 Inner welding pocket surfaces
32 mixer flange
33 mixer flange body
34 mixer
35 mixer shaft
36 mixer head
37 first mixer flange body portion
38 second mixer flange body portion
39 lateral mixer welding extension
40 welding edges
41 gear motor unit
42 secondary valve
43 temperature probe port
44 temperature probe
45 sampling valve port
46 sampling valve

1. An assembly of a pressure container and a valve device, wherein
said assembly comprises a tank base for said pressure container comprising a tank base body, said tank base body being made in a single piece; wherein
said tank base body comprises an annular connection edge, for connecting said tank base to said pressure container, and an inclined bottom wall, for allowing a fluid to flow, by gravity, towards a minimum portion thereof, said annular connection edge and inclined bottom wall delimiting a tank bottom cavity with edge surfaces and bottom wall surfaces converging towards said minimum portion; wherein
said minimum portion comprises a drainage opening for complete drainage, by gravity, of a fluid contained in said pressure container; and wherein
said inclined bottom wall is devoid of further drainage openings; and
said drainage opening is surrounded by a valve flange for connecting a clamp connection adapter unit, which converts a bolt compression connection into a clamp compression connection for interchangeably connecting the valve device to said tank base.

2. The assembly of claim 1, wherein
said valve flange delimits, in a portion thereof opposite to said tank bottom cavity, a valve coupling seat delimited close to said drainage opening by at least one valve support plane opposite to said tank bottom cavity, and wherein
said valve support plane is externally delimited by a valve seat edge in a thickness of which there are provided threaded blind holes adapted to accommodate threaded stems protruding from said valve seat edge.

3. The assembly of claim 1, wherein said tank base comprises a clamp connection adapter unit.

4. The assembly of claim 3, wherein said valve flange delimits, in a portion thereof opposite to said tank bottom cavity, a valve coupling seat delimited close to said drainage opening by at least one valve support plane opposite to said tank bottom cavity, wherein said valve support plane is externally delimited by a valve seat edge in a thickness of which there are provided threaded blind holes adapted to accommodate threaded stems protruding from said valve seat edge, wherein
said clamp connection adapter unit is a Zero Dead Leg connection flange, comprising at least two clamps extending about said drainage opening, each for an arc equal to, or less than 180DEG; wherein
each clamp comprises an arched connection portion and a folded tightening portion; wherein
said folded tightening portion enters said valve coupling seat and faces said valve support plane creating a support and tightening counter-surface; wherein
said valve seat edge with the threaded blind holes accommodates the threaded stems protruding from said valve seat edge; wherein
said arched connection portion faces said valve seat edge and connection seats thereof accommodate portions of said threaded stems; and wherein
tightening bolts are screwed to free ends of the threaded stems and tighten said at least two clamps so as to sandwich a valve flange of the valve device between the support and tightening counter-surfaces and said valve support plane.

5. The assembly of claim 1, wherein
a mixer opening is made in said inclined bottom wall, which is not adapted to drain fluid, wherein alternatively;
said mixer opening is a through opening that puts a welding pocket in communication with said tank bottom cavity;
or
said mixer opening is a circular through opening that puts a welding pocket in communication with said tank bottom cavity; wherein
a mixer flange is firmly connected to said mixer opening for seal connection of a mixer; and wherein
said mixer flange and said mixer occlude said mixer opening.

6. The assembly of claim 5, wherein said assembly comprises said mixer flange and said mixer flange is inserted and welded to edges of said mixer opening.

7. The assembly of claim 5, wherein said welding pocket has a D plan shape.

8. The assembly of claim 5, wherein
said welding pocket is delimited by said inclined bottom wall and welding pocket edges forming inner welding pocket surfaces, and wherein
the inner welding pocket surfaces are divergent moving away from said inclined bottom wall.

9. The assembly of claim 5, wherein said mixer flange comprises a mixer flange body for supporting the mixer.

10. The assembly of claim 5, wherein said mixer flange comprises a mixer flange body for accommodating a mixer shaft and rotatably freely supporting a mixer head at least partially inside said tank bottom cavity.

11. The assembly of claim 5, wherein
said mixer flange comprises a mixer flange body;
said mixer flange body comprises a first mixer flange body portion extending into said tank bottom cavity; and
said mixer flange body comprises a second mixer flange body portion extending away from said inclined bottom wall.

12. The assembly of claim 11, wherein said second mixer flange body portion is at least partially accommodated in said welding pocket.

13. The assembly of claim 5, wherein
said mixer flange comprises at least one lateral mixer welding extension; and
said at least one lateral mixer welding extension comprises welding edges adapted to be welded to edges of said mixer opening.

14. The assembly of claim 5; wherein
said assembly further comprises a mixer; wherein
said mixer comprises a mixer head supported on a side of the inclined bottom wall delimiting said tank bottom cavity; wherein
said mixer comprises a gear motor unit adapted to move said mixer head; and wherein
said gear motor unit is secured by said mixer flange welded to said inclined bottom wall.

15. The assembly of claim 1, wherein said assembly comprises said tank base, a mixer and a valve device for intercepting a process fluid.

16. The assembly of claim 1, wherein said assembly comprises said tank base, a mixer, and a valve device for intercepting a process fluid, and a secondary valve for intercepting a cleaning fluid, and wherein said secondary valve is fluidically joined to said valve device.

17. The assembly of claim 1, wherein said annular connection edge comprises a temperature probe port for fluidically sealably connecting a temperature probe, thus without allowing a fluid to drain, and detecting temperature of a fluid contained in said tank bottom cavity.

18. The assembly of claim 1, wherein said annular connection edge comprises a sampling valve port for fluidically sealably connecting a sampling valve, without allowing complete drainage of a fluid, and collecting a sample of fluid, also in very small residual volumes of fluid, contained in said tank bottom cavity.

19. A valve device assembly and a tank base, wherein
said tank base is adapted to be connected to a pressure container; and wherein
said tank base comprises a tank base body, tank base body being made in a single piece; wherein
said tank base body comprises an annular connection edge, for connecting said tank base to said pressure container, and an inclined bottom wall, for allowing a fluid to flow, by gravity, towards a minimum portion thereof, said annular connection edge and inclined bottom wall delimiting a tank bottom cavity with edge surfaces and bottom wall surfaces converging towards said minimum portion; wherein
said minimum portion comprises a drainage opening for complete drainage, by gravity, of a fluid contained in said pressure container; wherein
said inclined bottom wall is devoid of further drainage openings; wherein
said drainage opening is surrounded by a valve flange for connecting a clamp connection adapter unit, which converts a bolt compression connection into a clamp compression connection for interchangeably connecting a valve device to said tank base; wherein
a mixer opening is made in said inclined bottom wall, which is not adapted to drain fluid; wherein
said mixer opening is a through opening that puts a welding pocket in communication with said tank bottom cavity; wherein
and wherein a mixer flange is firmly connected to said mixer opening for seal connection of a mixer; and wherein
said mixer flange and said mixer occlude said mixer opening.

20. A set of assemblies according to claim 1, comprising a plurality of tank base assemblies, wherein said tank bases each comprise a mixer opening, and wherein
the mixer openings of the tank bases have different extension sizes from one another, and wherein
a respective mixer flange is firmly connected to each mixer opening for seal connection of a mixer.

21. A set of assemblies according to claim 1, comprising at least one tank base, wherein said tank base comprises a mixer opening and wherein a mixer flange selected from a set of mixer flanges of different sizes is firmly connectable to said mixer opening for the seal connection of a mixer.

22. The set of assemblies of claim 20, wherein
all mixer flanges comprise a lateral mixer welding extension having welding edges of identical size; wherein
each mixer flange comprises a mixer flange body; said mixer flange body comprises a first mixer flange body portion adapted to extend into a tank bottom cavity; said mixer flange body comprises a second mixer flange body portion adapted to extend away from an inclined tank base bottom wall; and wherein said second mixer flange body portion is adapted to be at least partially accommodated in a tank base welding pocket; and wherein
each mixer flange has a size and/or shape of said first mixer flange body portion, which is different from the other mixer flanges of a same set of mixer flanges.

23. The set of assemblies of claim 20, wherein
each mixer flange comprises a mixer flange body; said mixer flange body comprises a first mixer flange body portion adapted to extend into a tank bottom cavity; said mixer flange body comprises a second mixer flange body portion adapted to extend away from an inclined tank base bottom wall; and wherein said second mixer flange body portion is adapted to be at least partially accommodated in a tank base welding pocket; and wherein
each mixer flange has a size and/or shape of said second mixer flange body portion, which is different from the other mixer flanges of a same set of mixer flanges.

24. A method for manufacturing a tank base, the method comprising, alternatively,
melting and machining, by swarf removal, a tank base having the features set forth in claim 1;
or
machining, by swarf removal from a full piece, a tank base having the features set forth in claim 1.

25. A method for manufacturing a tank base assembly, the method comprising:
providing an assembly of a pressure container and a valve device, wherein
said assembly comprises a tank base for said pressure container comprising a tank base body, said tank base body being made in a single piece; wherein
said tank base body comprises an annular connection edge for connecting said tank base to said pressure container, and an inclined bottom wall for allowing a fluid to flow, by gravity, towards a minimum portion thereof, said annular connection edge and inclined bottom wall delimiting a tank bottom cavity with edge surfaces and bottom wall surfaces converging towards said minimum portion; wherein
said minimum portion comprises a drainage opening for complete drainage, by gravity, of a fluid contained in said pressure container; and wherein
said inclined bottom wall is devoid of further drainage openings; and
said drainage opening is surrounded by a valve flange for connecting a clamp connection adapter unit, which converts a bolt compression connection into a clamp compression connection for interchangeably connecting the valve device to said tank base; and
connecting to said valve flange a clamp connection adapter unit, which converts a bolt compression connection into a clamp compression connection for interchangeably connecting the valve device to said tank base.

26. The method of claim 25, further comprising:
making a mixer opening in said inclined bottom wall; and
welding a mixer flange to edges of said mixer opening.

27. The method of claim 26, further comprising:
connecting a mixer to said mixer flange; and
connecting the valve device to said clamp connection adapter unit.
